(19) United States
(12) Patent Application Publication
(10) Pub. No.: US 2007/0006585 A1
(43) Pub. Date: Jan. 11, 2007

(54) Charged Air Supercooler for internal combustion engines

(75) Inventor: Doreen R Nation, Crestwood, KY (US)

Correspondence Address: MRS. DOREEN R. NATION, 5100 REYNOLDS RUN RD., CRESTWOOD, KY, 40014, US

(73) Assignee: Doreen R Nation, Crestwood, KY (US)

(21) Appl. No.: 11/160,798

(22) Filed: Jul. 9, 2005

(51) Int. Cl. F02B 29/04; F02B 33/44

(52) U.S. Cl. 60/599; 60/605.1

(57) ABSTRACT

A method of delivering cool dense intake air to an engine intake using a supercharger to compress air for delivery to an intercooler, where air is cooled and allowed to pass to an expansion valve allowing a pressure and temperature drop for cool dense air delivery to the engine.

### TECHNICAL FIELD

Cooling of intake air for supercharged or turbocharged internal combustion engines.

### BACKGROUND

Superchargers and Turbochargers increase the mass flow of air to an internal combustion engine. This increase of mass flow is produced by pressurizing the air prior to entering the combustion chamber. Intercoolers have been introduced between these chargers and internal combustion engines to allow and even denser air charge, at a more acceptable lower temperature, for internal combustion engines with the existing limitations of available fuels. Charging of air prior to entering the combustion chamber not only increases the mass of the air entering the cylinder, but also effectively increases the compression ratio of the combustion system. The cooling of charged air prior to entering the combustion chamber also allows for an increased specific heat ratio as compared to non-intercooled systems. Both of these increases are desirable and relate to increased performance as well as increased efficiency as described by the thermodynamic principles of the Otto Cycle.

### DRAWINGS

FIG. 1 is a schematic of a standard refrigeration cycle.

FIG. 2 is a schematic of the inventive change to the cooling cycle of charged air entering an engine.

### DETAILED DESCRIPTION OF THE INVENTION

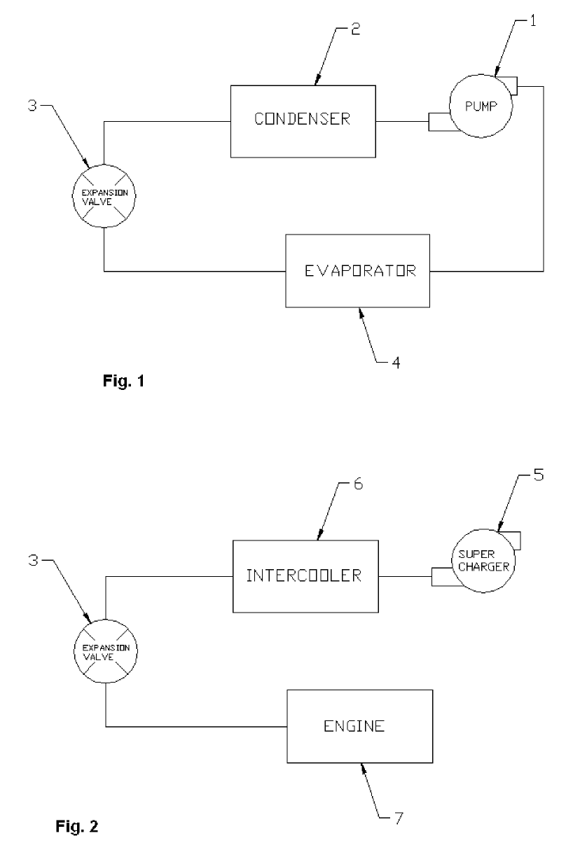

FIG. 1 illustrates the components of a standard closed loop refrigeration cycle where a refrigerant is compressed by a pump 1 and flows to a condenser 2 where it sheds heat and it then expanded through an expansion valve 3 where temperature and pressure of the refrigerant drops after which it returns to an evaporator 4 where it absorbs heat again to continue the refrigeration cycle. The fundamentals allowing the refrigerant to shed heat and become cool again are applied by the invention.

FIG. 2 illustrates ambient air being compressed by a charger 5 increasing its pressure and thereby its temperature. The compressed air enters the intercooler 6 at a state which freely sheds heat, as its temperature is clearly higher than ambient. At the exit of the intercooler the charged air has the same pressure it entered with, only at a reduced temperature. The invention allows for even greater cooling by allowing the air to exit through an expansion valve 3 at some pressure lower than the pressure in the intercooler 6. The standard thermodynamic property of a gas is that temperature will decrease with the decrease in its pressure.

The invention treats the actual intake air as a refrigerant by over-compressing it, removing heat from it and then allowing it to expand to some pressure lower than the exit pressure from the charger 5. By passing the air through the intercooler 6 at some pressure higher than the engine intake pressure, the air is super-cooled as compared to conventional intercooling.

The invention allows the expansion of the exit air from an intercooler 6 to be controlled by means of an expansion valve 3 metering exit air at a reduced pressure to the engine 7 intake. The invention allows for a significant increase in mass flow of air using readily available fuels as compared to conventional methods of charging and cooling.

What is claimed is:

1. A method of delivering cool dense intake air to an engine intake, the method comprising:
a turbocharger to compress air for delivery to an intercooler, where air is cooled and allowed to pass to an expansion valve; and
the expansion valve controls pressure differential between the intercooler and the engine intake allowing a pressure and temperature drop for cool dense air delivery to the engine.

2. A method of delivering cool dense intake air to an engine intake, the method comprising:
a supercharger to compress air for delivery to an intercooler, where air is cooled and allowed to pass to an expansion valve; and
the expansion valve controls pressure differential between the intercooler and the engine intake allowing a pressure and temperature drop for cool dense air delivery to the engine.

3. A method of delivering cool dense intake air to an engine intake, the method comprising:
a compressor to compress air for delivery to an intercooler, where air is cooled and allowed to pass to an expansion valve; and
the expansion valve controls pressure differential between the intercooler and the engine intake allowing a pressure and temperature drop for cool dense air delivery to the engine.

4. The method of claim 1 including sensing engine conditions other than intake pressure and using a microprocessor in order to control pressure drop through the expansion valve.

5. The method of claim 2 including sensing engine conditions other than intake pressure and using a microprocessor in order to control pressure drop through the expansion valve.

6. The method of claim 3 including sensing engine conditions other than intake pressure and using a microprocessor in order to control pressure drop through the expansion valve.
